(19) United States
(12) Patent Application Publication
(10) Pub. No.: US 2020/0065350 A1
(43) Pub. Date: Feb. 27, 2020

(54) SYSTEM AND METHOD FOR PLATFORM-AGNOSTIC DISPLAY OF WEB CONTENT WITH STATIC TRANSITIONS

(71) Applicant: Jump Browser LLC, Reunion, FL (US)

(72) Inventor: Jose Luis Javier Colayco, Reunion, FL (US)

(21) Appl. No.: 16/546,172

(22) Filed: Aug. 20, 2019

Related U.S. Application Data
(60) Provisional application No. 62/720,735, filed on Aug. 21, 2018.

(51) Int. Cl. G06F 16/957; G06F 16/958; G06F 3/0484

(52) U.S. Cl. CPC G06F 16/9577; G06F 3/04845; G06F 16/986

(57) ABSTRACT

A method for platform-agnostic display of web content with static transitions includes receiving, via a network interface, at a terminal comprising a processor, a memory and a screen having a first screen height, content for display on the terminal, obtaining an analysis of the web content to determine an effective page height, the effective page height based in part on the first screen height, determining a first portion of the web content to fit the effective page height, and displaying the first portion of the web content on the screen at the effective page height.

### CROSS-REFERENCE TO RELATED APPLICATION AND CLAIM OF PRIORITY

This application claims priority under 35 U.S.C. § 119(e) to U.S. Provisional Patent Application No. 62/720,735 filed Aug. 21, 2018. The above-identified provisional patent application is hereby incorporated by reference in its entirety.

### TECHNICAL FIELD

This disclosure relates generally to user interface technology. More specifically, this disclosure relates to a system and method for platform-agnostic display of web content with static transitions.

### BACKGROUND

With generally trivial exceptions, the appearance of web content on a screen is dictated by the browser rendering the underlying document containing the web content. Further, due to the nature of popular languages (for example, HTML) for authoring web content and stylistic conventions to facilitate quick and reliable rendering, web content is typically rendered such that a page of web content exceeds the height of the screen on which it is presented, with the expectation that users will advance through the text by scrolling. On certain portable browsing platforms with small screens (smart phones, tablets and smart watches, to name a few), reading, or navigating a single web document can involve repeated scrolling. As web contents get longer, scrolling becomes, from a user experience and user interface (UX/UI) perspective, an inefficient way of navigating a document, as it requires many swipes across a screen. Additionally, as web documents get longer, certain modes of content navigation (for example, vertical sliders in the screen margins) impose an unwanted tradeoff between navigating quickly (e.g., a user can move the slider to rapidly advance through the document) or navigating accurately (e.g., scrolling through all of the content to get to a desired section).

For some web users, the user experience associated with scrolling (for example, with a mouse, or by dragging a finger across a touch screen) is an unfavorable departure from moving through content in discrete blocks of generally equal length (for example, by turning the pages of a book). Further, for certain web users, the user experience associated with scrolling through content is associated with digital motion sickness, a species of visually induced motion sickness associated with certain users' reaction to observing moving objects on a digital screen. Thus, opportunities remain for providing mechanisms for navigating web content which allow users to navigate web documents quickly, accurately and without transitions which may trigger motion sickness in certain users.

### SUMMARY

This disclosure provides a system and method for platform-agnostic display of web content with static transitions.

In a first embodiment, a method for platform-agnostic display of web content with static transitions includes receiving at a terminal comprising a processor, a memory and a screen having a first screen height, content for display on the terminal, obtaining an analysis of the web content to determine an effective page height, the effective page height based in part on the first screen height, determining a first portion of the web content to fit the effective page height, and displaying the first portion of the web content on the screen at the effective page height.

In a second embodiment, an apparatus includes a screen having a first screen height, a network interface, a processor and a memory containing program code. When executed by the processor, the program code causes the apparatus to receive, via the network interface, web content for display on the terminal, obtain an analysis of the web content to determine an effective page height, the effective page height based in part on the first screen height, determine a first portion of the web content to fit the effective page height, and display the first portion of the web content on the screen at the effective page height.

In a third embodiment, a non-transitory computer-readable medium includes program code, which when executed by a processor, causes a terminal to receive, at the terminal comprising the processor, the memory and a screen having a first screen height, web content for display on the terminal, obtain an analysis of the web content to determine an effective page height, the effective page height based in part on the first screen height, determine a first portion of the web content to fit the effective page height and display the first portion of the web content on the screen at the effective page height.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of a device for implementing a platform-agnostic method for displaying web content with static transitions, according to various embodiments of this disclosure;

FIG. 2 illustrates an example of web content displayed on a terminal according to various embodiments of this disclosure;

FIG. 3 illustrates an example of operations of a method for providing a platform-agnostic method for displaying web content with static transitions, according to some embodiments of this disclosure;

FIG. 4 illustrates an example of operations of a method to determine an effective page height according to certain embodiments of this disclosure;

FIG. 5 illustrates an example of an implementation of a start bar and an end bar according to various embodiments of this disclosure; and

FIG. 6 illustrates an example of a jump bar for receiving user inputs according to various embodiments of this disclosure.

### DETAILED DESCRIPTION

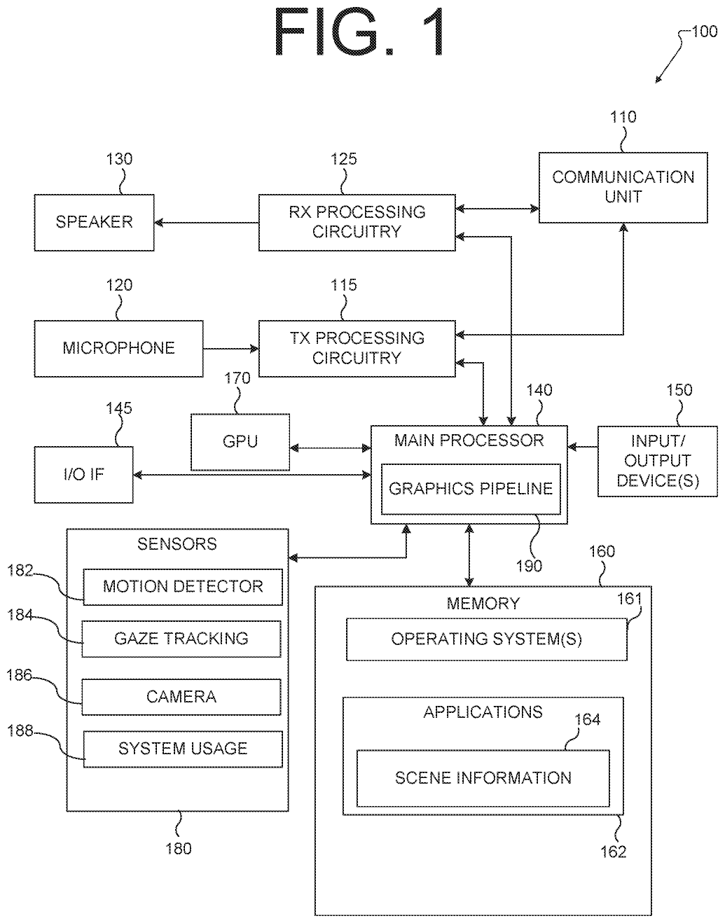

FIGS. 1 through 6, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged electronic device.

FIG. 1 illustrates an example of a device for implementing a platform-agnostic method for displaying web content with static transitions according to certain embodiments of this disclosure. The embodiment of device 100 illustrated in FIG. 1 is for illustration only, and other configurations are possible. However, suitable devices come in a wide variety of configurations, and FIG. 1 does not limit the scope of this disclosure to any particular implementation of a device.

As shown in FIG. 1, the device 100 includes a communication unit 110 that may include, for example, a radio frequency (RF) transceiver, a BLUETOOTH® transceiver, or a WI-FI® transceiver, etc., transmit (TX) processing circuitry 115, a microphone 120, and receive (RX) processing circuitry 125. The device 100 also includes a speaker 130, a main processor 140, an input/output (I/O) interface (IF) 145, input/output device(s) 150, and a memory 160. The memory 160 includes a plurality of operating system (OS) programs 161 and one or more applications 162. According to certain embodiments, plurality of OS programs 161 includes a host, or default operating system, as well as one or more guest operating systems which can be implemented on one or more containers provided by device 100.

Applications 162 can include legacy applications, or applications developed for, and having application logic tied to host or guest operating system programs on device 100. Additionally, applications 162 can output scene information 164 for rendering and presentation on an input/output device 150, such as a screen.

The communication unit 110 may receive an incoming RF signal such as a Bluetooth® or Wi-Fi® signal. The communication unit 110 may down-convert the incoming RF signal to generate an intermediate frequency (IF) or baseband signal. The IF or baseband signal is sent to the RX processing circuitry 125, which generates a processed baseband signal by filtering, decoding, and/or digitizing the baseband or IF signal. The RX processing circuitry 125 transmits the processed baseband signal to the speaker 130 (such as for voice data) or to the main processor 140 for further processing (such as for web browsing data, online gameplay data, notification data, or other message data).

The TX processing circuitry 115 receives analog or digital voice data from the microphone 120 or other outgoing baseband data (such as web data, e-mail, or interactive video game data) from the main processor 140. The TX processing circuitry 115 encodes, multiplexes, and/or digitizes the outgoing baseband data to generate a processed baseband or IF signal. The communication unit 110 receives the outgoing processed baseband or IF signal from the TX processing circuitry 115 and up-converts the baseband or IF signal to an RF signal for transmission.

The main processor 140 can include one or more processors or other processing devices and execute the basic OS program 161 stored in the memory 160 in order to control the overall operation of the device 100. For example, the main processor 140 could control the reception of forward channel signals and the transmission of reverse channel signals by the communication unit 110, the RX processing circuitry 125, and the TX processing circuitry 115 in accordance with well-known principles. In some embodiments, the main processor 140 includes at least one microprocessor or microcontroller.

The main processor 140 is also capable of executing other processes and programs resident in the memory 160. The main processor 140 can move data into or out of the memory 160 as required by an executing process. In some embodiments, the main processor 140 is configured to execute the applications 162 based on the OS program 161 or in response to inputs from a user, sensors 180 or applications 162. Applications 162 can include applications specifically developed for the platform of device 100, or legacy applications developed for earlier platforms. The main processor 140 is also coupled to the I/O interface 145, which provides the device 100 with the ability to connect to other devices such as laptop computers and handheld computers. The I/O interface 145 is the communication path between these accessories and the main processor 140.

The main processor 140 is also coupled to the input/output device(s) 150. The operator of the device 100 can use the input/output device(s) 150 to enter data into the device 100. Input/output device(s) 150 can include keyboards, touch screens, mouse(s), track balls or other devices capable of acting as a user interface to allow a user to interact with device 100. In some embodiments, input/output device(s) 150 can include a touch panel, a virtual reality headset, a (digital) pen sensor, a key, or an ultrasonic input device. Input/output device(s) 150 are, according to certain embodiments, associated with one or more of sensor(s) 180 to provide input to main processor 140.

Input/output device(s) 150 can include one or more screens, which can be a liquid crystal display, light-emitting diode (LED) display, an optical LED (OLED), an active matrix OLED (AMOLED), or other screens capable of rendering graphics. The one or more screens can include a plurality of display elements, such as electronically modulated light emitting diodes, that define a physical, or native resolution of a screen comprising input/output device(s) 150. For example, a WQRD display can have a physical resolution of 2560×1440 pixels. Additionally, screens can include a touchscreen capable of registering tactile inputs correlating with pixels of the screen and/or regions of the screen.

The main processor 140 can be configured to implement a graphics pipeline 190, including performing rendering and compositing operations according to control logic provided by basic operating system 161, applications 162 and/or other executable program code stored in memory 160.

The memory 160 is coupled to the main processor 140. According to certain embodiments, part of the memory 160 includes a random access memory (RAM), and another part of the memory 160 includes a Flash memory or other read-only memory (ROM). Although FIG. 1 illustrates one example of a device 100. Various changes can be made to FIG. 1.

For example, according to certain embodiments, device 100 can further include a separate graphics processing unit (GPU) 170, and sensors 180. Main processor 140 can offload processing tasks associated with implementing graphics pipeline 190 to GPU 170. Such graphics processing tasks can include, without limitation, shading, primitive assembly and/or rasterization.

Sensors 180 can comprise a variety of sensors for generating inputs processed by device 100, and include without limitation, accelerometers, digital cameras, touch sensors, digital thermometers, pressure sensors and global positioning system sensors. For example, sensors 180 can include a motion detector 182. Motion detector 182 can be an optical sensor, an accelerometer or a gyroscopic sensor. Additionally, motion detector 182 can comprise multiple motion detectors, such as motion detectors coupled to a user's head and/or limbs. Additionally, sensors 184 may include cameras and other sensors 184 suitable for performing gaze tracking of a user's eyes, to detect which portions of the screen a user's gaze is focused upon. Sensors 180 can include additional cameras 186, including cameras disposed on the back side of screen, including sensors for providing an augmented reality (AR) experience, in which digital images are superimposed over the view of a camera positioned on or near a user's eye. Further, sensors 180 can include sensors 188 configured to monitor the usage of system resources, including, without limitation, main processor 140, GPU 170 and/or memory 160.

Although FIG. 1 illustrates one example of a device 100 implementing a platform-agnostic method for displaying web content with static transitions according to certain embodiments of this disclosure, various changes may be made to FIG. 1. For example, the device 100 could include any number of components in any suitable arrangement. In general, devices including computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

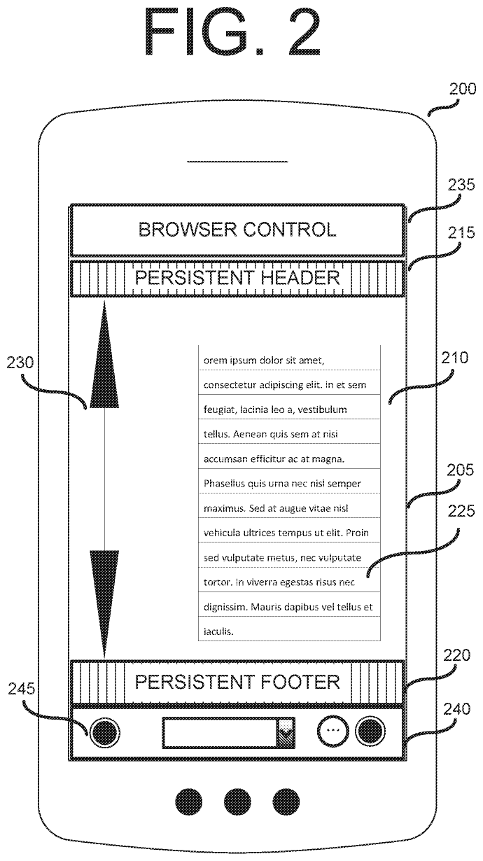

FIG. 2 illustrates an example of web content displayed on a terminal according to various embodiments of this disclosure.

As discussed elsewhere in this disclosure, web content (for example, web pages) is typically rendered on the assumption that the reader will navigate, or advance through the content by scrolling, or moving the displayed text up and down on the screen towards content of interest. The motion of the displayed text can, for certain users, induce motion sickness. Certain embodiments according to this disclosure provide a platform-agnostic (as used herein, the term platform-agnostic encompasses the qualities of being implementable on any screen size and any device with a web browser) method for static transitions for navigating web content. As used herein, the term “static transition” encompasses changes in the displayed content which, to the user's eye appear discontinuous (e.g., the text does not appear to be sliding up or down the screen).

The technical challenges associated with implementing displaying web content with static transitions include, without limitation, handling persistent headers and footers included in web content. As used in this disclosure, the terms “persistent headers and footers,” encompass elements of a web page that are rendered to remain in a substantially fixed region of the display (e.g., a header at the top of the page, or a footer at the bottom). Persistent headers and footers present technical challenges for implementing static transitions by requiring that the size and location of the effective portion (referring to the part of the display which moves when scrolled) be identified, and that static transitions be implemented in just this region. Put differently, attempting to implement static transitions by simply “jumping” a length corresponding to the height of the display does not work, as this method fails to account for persistent headers and footers, resulting in “jumping” too far ahead in the content.

Referring to the non-limiting example of FIG. 2, a terminal 200 is shown. Terminal 200 may be any suitable device (for example, device 100 in FIG. 1) capable of receiving web content and presenting same through a browser, including, without limitation, a smart phone, a tablet, or a smart watch. As shown in FIG. 2, terminal 200 includes at least one screen 205, which has a first screen height, measured in the direction in which rendered content is scrolled. Put differently, in embodiments where the phone is held vertically and the text is oriented as shown in FIG. 2, the first screen height corresponds to the length of the long edge of the screen. In embodiments where the phone is held horizontally, and the text is rotated 90 degrees, the first screen height corresponds to the length of the short edge of the screen.

According to certain embodiments, terminal 200 includes one or more browser programs, through which web content 210 received at the terminal can be displayed on screen 205. In some embodiments, web content 210 is received page code (for example, an HTML document) with one or more associated presentation documents (for example, a cascading style sheet (CSS) or .XSL file), which are rendered for presentation by a browser application on terminal 200.

In the non-limiting example of FIG. 2, web content 210 is rendered such that it comprises at least three main display elements, each of which are shown below browser control 235—a persistent header 215, a persistent footer 220 and scrollable content 225. In some embodiments, persistent header 215 and persistent footer 220 may be implemented through instances of the .sticky class, and are rendered such that they remain in the same or substantially the same position on the displayed page, while the text and images in scrollable content 225 move up and down in response to navigational inputs from a user.

The presence of a persistent header and/or footer reduces means that not all of the usable display area of the screen (for example, browser control 235, may in some embodiments, be persistent) can be used to display scrollable web content. In effect, the presence of these persistent elements reduces the effective height of the page. The effective page height 230 of screen 205 is shown in FIG. 2.

According to certain embodiments, to keep from advancing too far, the maximum possible stride for static transitions within a displayed piece of web content is effective page height 230.

As shown in the non-limiting example of FIG. 2, in certain embodiments, a navigation bar 240 may be provided on the screen. In this particular example, navigation bar 240 is shown as being superimposed over persistent footer 220. In some embodiments, navigation bar 240 may be “sticky” and remain at a given position on screen 205. In certain embodiments, navigation bar 240 may be transitory, and retreat from view after a predetermined time. According to the illustrative example of FIG. 2, navigation bar 240 may include one or more buttons 245 configured for navigating within the web content (for example, an “up button” for navigating towards an immediately preceding section. Navigation bar 240 may further comprise one or more pull-down menus or buttons to trigger the display of a pop-up menu.

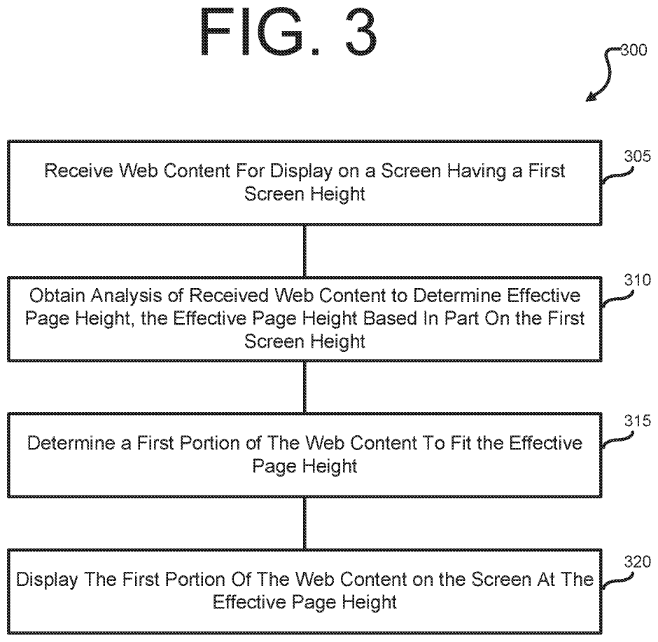

FIG. 3 illustrates an example of operations of a method 300 for providing a platform-agnostic method for displaying web content with static transitions, according to some embodiments of this disclosure.

In the non-limiting example of FIG. 3, the described operations are performed by a program running on a device which receives, renders and displays web content, such as an application or a plug-in to a browser. However, the present disclosure is not limited thereto, and other embodiments, wherein the operations described with reference to FIG. 3 are split across multiple computing platforms are possible and within the contemplated scope of this disclosure.

According to certain embodiments, at operation 305, a terminal receives web content for display on a screen having a first screen height. In some embodiments, the web content is received over a network (for example, the internet). In certain embodiments, the web content is received from elsewhere, such as from a file folder on the device (for example, a saved HTML document to be rendered and presented by the browser).

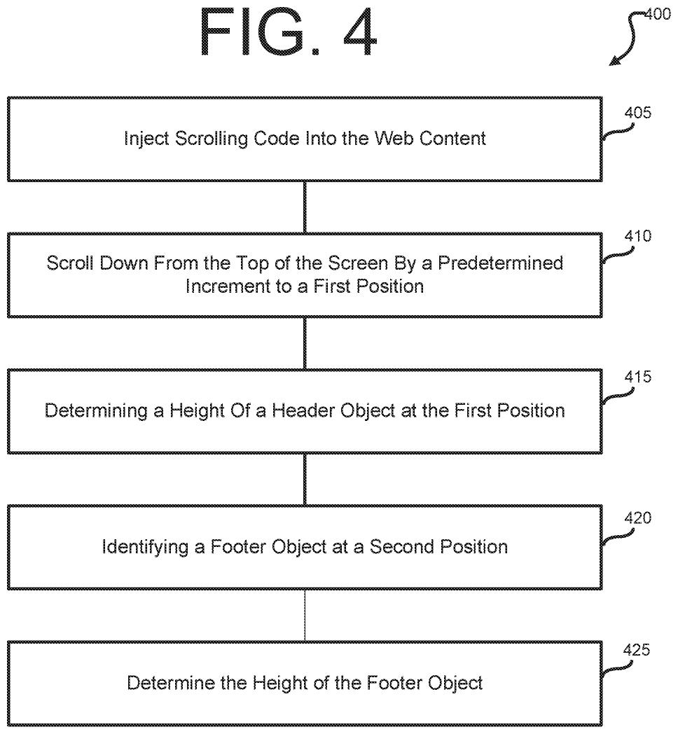

As shown in the non-limiting example of FIG. 3, at operation 310, the terminal obtains an analysis of the received content to determine an effective page height, the effective page height based in part on the first screen height. In some embodiments, the analysis obtained at operation 310 is performed at the terminal (for example, using the method described with reference to FIG. 4 herein). According to certain embodiments, the analysis of the effective page height may be obtained over a network from another device (for example, an analysis server analyzing the page structure of popular websites).

In some embodiments, the effective page height determined at operation 310 is based on the first height of the screen and corresponds to the full distance between the bottom edge of a header and the upper edge of a footer (for example, effective page height 230 in FIG. 2).

In various embodiments according to this disclosure, at operation 315, the terminal determines a first portion of the web content received at 305 to fit the effective page height. In some embodiments, the determination of a first portion of the web content to fit the effect page height comprises identifying a section of content beginning at a predefined start point (for example, the row of pixels line immediately above the top of a persistent footer) and ending at a predetermined end point exactly one effective page height further in the document. According to some embodiments, the portion of the web content to fit the effective page height comprises a subset of the web content between the last line of the currently displayed page, and a line exactly one effective page height further in the document. This subset may be programmatically selected to avoid cropping pictures or other graphical elements in the web content, or cropping text at the top and bottom lines of a page. In some embodiments, the portion of the web content selected at operation 315 may be selected to include some portion of a section of a document presented prior to a static transition, thereby providing the reader with some navigational context.

In some embodiments according to this disclosure, at operation 320, the terminal displays the first portion of the web content on the screen at the effective page height, along with the persistent header and/or persistent footer.

Although FIG. 3 illustrates one example of operations of a method 400 to determine an effective page height in preparation for performing a static transition, according to certain embodiments of this disclosure, other embodiments are possible. For example, in certain embodiments, web content may not include either “sticky” headers or footers, but may instead include content items (for example, pictures) which can affect the effective height of the screen and the forward stride of a static transition.

According to some embodiments, the analysis of the effective page height and determination of the stride of a static transition within the content may be performed remotely. For example, in certain embodiments, a viewing device (for example, device 100 in FIG. 1) may capture a screenshot of currently displayed content on a device and perform analysis of the content to identify persistent page items to be subtracted from the effective page height.

FIG. 4 illustrates an example of operations of a method 400 to determine an effective page height according to certain embodiments of this disclosure.

As discussed elsewhere in this disclosure (for example, with reference to operation 310 in FIG. 3), certain embodiments determine the effective page height of web content to be displayed on a screen, the determination based in part on the first screen height of the display.

Referring to the non-limiting example of FIG. 4, some embodiments according to this disclosure leverage certain browsers' ability to scroll through a web document too quickly for a user to notice to determine the effective page height of web content to be displayed, and in certain embodiments, to perform a static transition within the web content.

In certain embodiments according to this disclosure, at operation 405, an application for implementing static transitions (for example, a standalone viewing application or a browser plugin) injects scrolling code (for example, JavaScript code) into the underlying code for web content. According to certain embodiments, the scrolling code is injected into the page code at the time the page code is loaded and causes the page to automatically scroll in a predetermined direction. Given the available processing power of most devices for viewing web content, the scrolling triggered by the scrolling code is completed almost instantaneously and is imperceptible to a user.

According to various embodiments, at operation 410, the application calls the injected code (for example, in response to an input at a user interface to navigate forwards in the web content), and the application scrolls down from the top of the screen by a predetermined increment to a first position. In some embodiments, (for example, on widely available smartphones), a predetermined increment of approximately 20 pixels has proven effective. At the first position, the application performs a determination of whether, during the course of this initial scroll, there is any object at the top of the screen which has not changed position as a result of this initial scroll. According to certain embodiments, multiple initial scrolls may be performed, including a scroll to the end of the document to determine the overall length of the document. In some embodiments, such an initial scroll to determine the length of the document can perform a gating function, as if the document as a whole fits within the displayed screen, then there is no need to determine the effective page height to set up subsequent static transitions.

In some embodiments, when the initial scroll performed at operation 410 identifies an object at the top of the screen which has not moved in response to the initial scroll, the object is assumed to be a persistent header, or header object. At operation 415, the height of the header object is determined. According to some embodiments, the height of the header is determined based on the distance from the bottom of the header object to the bottom of the browser control. As used in this disclosure, the term “browser control” encompasses a frame or toolbar displayed at the top of the screen and through which navigational inputs (for example, web site addresses and search terms) can be entered.

In certain embodiments, at operation 420, the application repeats the analysis of operation 415 at the bottom end of the screen, by determining whether any objects at the bottom of the screen did not move in response to the initial scroll performed at operation 410. Content at the bottom of the screen which does not move in response to the initial scroll can, in certain embodiments, be safely assumed to be a persistent footer, and identified as a footer object at a second position (for example, a range of pixel rows at the bottom of the screen).

According to various embodiments, at operation 425, the height of the footer object identified at operation 420 is determined. The height can, in some embodiments, be determined from the distance from the top of the footer object to the bottom of the browser control. Having determined the height of the header object and the footer object, the effective page height can be determined, and the page programmatically scrolled forward in an amount less than or equal to the effective page height.

Although FIG. 4 illustrates one example for determining an effective page height of web content in connection with performing static transitions, embodiments according to this disclosure are not limited thereto. For example, in some embodiments, the effective height of the screen may be determined by analyzing the code of a web page to identify tags signaling the placement of static transition points.

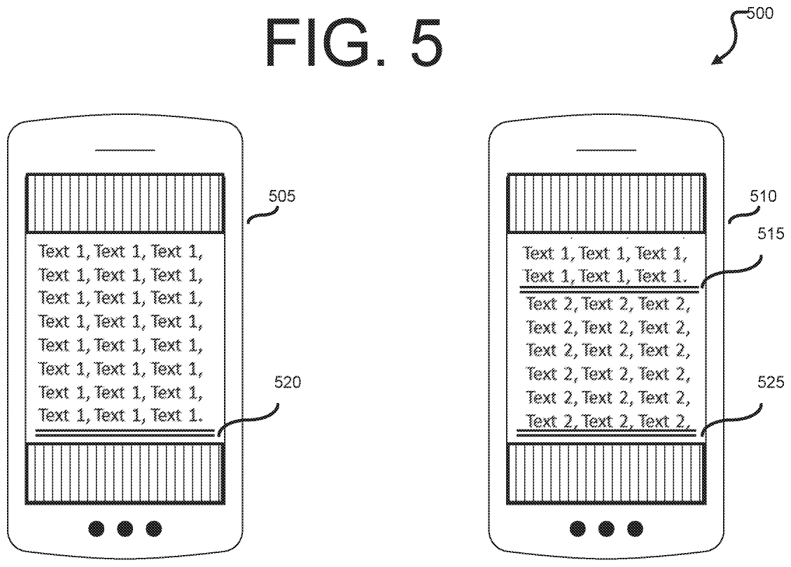

FIG. 5 illustrates an example 500 of an implementation of a start bar and an end bar according to various embodiments of this disclosure. As discussed elsewhere herein, to facilitate the user experience and preserve context, it is, in certain embodiments, possible to perform a static transition that does not advance by the maximum possible stride within the web document. According to such embodiments, a portion of content from the previously viewed section remains visible after the transition. Further, in some embodiments, static transitions according to certain embodiments may not advance the same number of pixels each time (for example, to avoid unwanted cropping of images in a document). To improve the user experience, certain embodiments display one or both of a “start line” and an “end line” after a static transition, to signal the demarcation of previously and newly displayed content to a viewer.

Referring to the non-limiting example of FIG. 5, a first view 505 of a terminal displaying the beginning of a piece of web content which includes a persistent header and footer is shown on the left side of the figure. A second view 510 of the terminal is shown on the right side of the figure. As shown in this non-limiting example, the terminal has performed a static transition to a new section of the web content (shown as “Text 2”), while retaining a portion of the previously visible web content (shown as “Text 1”). To enhance the viewing experience and make the demarcation between the old and new content more apparent to the reader, in first view 505, a first end line 520 is shown on the screen to signal the end of a displayed section.

After triggering a static transition to navigate forwards in the web content, a start line 515 is presented on the display of the terminal. In this non-limiting example, start line 515 occupies the same location within the web content as previously displayed first end line 520. According to certain embodiments, start line 515 may be transitory, and disappear a few seconds after the transition. In some embodiments, start line 515 can be configured to be persistent, as it has been shown that some users find the continued presence of start line 515 to be a useful aid for navigating within a document. According to some embodiments, start line 515 may be semi-transparent and composed of a non-obtrusive color (for example, light yellow or non-photo blue). Additionally, following the static transition to navigate forwards, a new, second end line 525 is displayed on the screen. According to various embodiments, the end line of a section (for example, second end line 525) can be configured to conditionally disappear (for example, after the passage of a preset period of time), or be persistently visible, to help demarcate a section of unread text.

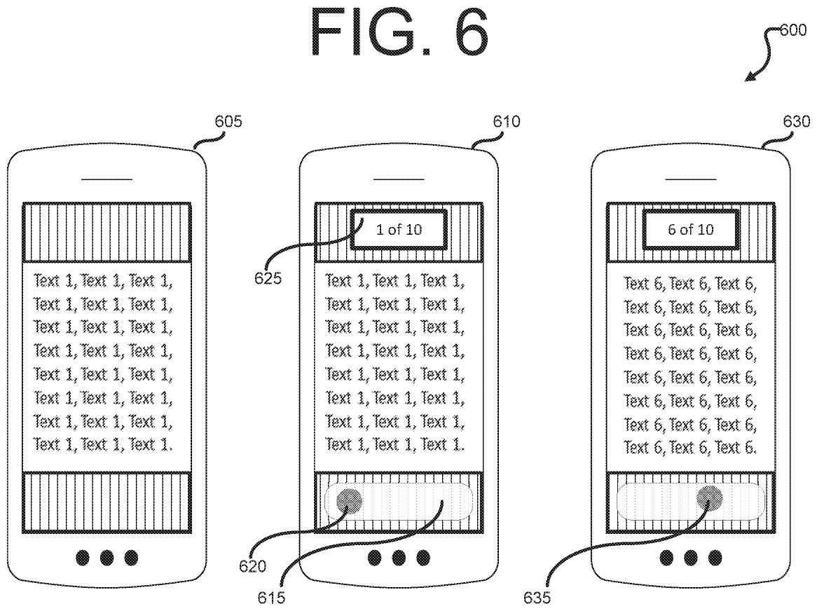

FIG. 6 illustrates an example 600 of a jump bar for receiving user inputs according to various embodiments of this disclosure.

Referring to the non-limiting example of FIG. 6, a first view 605 of a terminal displaying web content including (in this illustrative example), both a persistent header and a persistent footer is shown on the left side of the figure.

In the example of FIG. 6, a second view 610 of the terminal, including a jump bar 615 user interface for controlling static transitions within the web content is displayed. According to certain embodiments, jump bar 615 provides users with an interface for controlling a number of static transitions they wish to perform to advance forwards or backwards within a scrollable web document. As shown in the non-limiting example of FIG. 6, jump bar 615 provides a region for tap and drag inputs 620. For example, jump bar 615 may be configured such that a single tap triggers a single static transition, while a swiping gesture triggers multiple static transitions. Additionally, a progress indicator 625 may be displayed in conjunction with jump bar 615. In some embodiments, progress indicator 625 may display the number of static transitions required to navigate to the end of the document. In this way, static transitions become a proxy for pagination of scrollable web content, thereby allowing a user to bookmark sections within web content, or otherwise navigate efficiently to points of interest.

In this illustrative example, a third view 630 of the terminal is shown on the right hand side of the figure. In this one, a user provided a drag input 635 to the jump bar, triggering 5 static transitions to a region of the web content identified as point “6 of 10.”

According to certain embodiments, including, without limitation, pages (for example, accelerated mobile pages (“.AMP pages”)) which are to be presented in an inline frame (also known as an “iframe”), the use of an iframe may preclude a determination of the length of the document, and by implication, knowledge of how many static transitions may be required to navigate the document. From the perspective of the viewing device, the length of the document is the area of the iframe on the screen, even though the user may be able to scroll, within the iframe, through a body of content that has a length much greater than the height of the iframe. To implement static transitions within such documents, certain embodiments dispense with performing an initial scroll to determine the overall length of the document, and instead assume that the document is less than an arbitrarily high length for an iframe. In this way, static transitions may be performed within the iframe.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A platform-agnostic method for displaying web content with static transitions, the method comprising:
receiving, at a terminal comprising a processor, a memory and a screen having a first screen height, web content for display on the terminal;
obtaining an analysis of the web content to determine an effective page height, the effective page height based in part on the first screen height;
determining a first portion of the web content to fit the effective page height; and
displaying the first portion of the web content on the screen at the effective page height.

2. The method of claim 1, wherein the analysis of the web content is obtained, via a network from another device.

3. The method of claim 1, further comprising, providing on the screen, a jump bar for receiving user inputs.

4. The method of claim 1, further comprising:
responsive to receiving an input at the terminal, determining a second portion of the web content to fit the effective page height; and
displaying the second portion of the web content on the screen at the effective page height.

5. The method of claim 4, wherein the second portion is displayed on the screen below a start line.

6. The method of claim 4, wherein the second portion of the web content comprises web content within the first portion of the web content.

7. The method of claim 4, further comprising:
injecting scrolling code into the web content;
scrolling down from the top of the screen by a predetermined increment, to a first position;
determining a height of a header object at the first position;
identifying a footer object at a second position; and
determining the height of the footer object.

8. An apparatus, comprising:
a screen having a first screen height;
a network interface;
a processor; and
a memory, containing program code, which when executed by the processor, causes the apparatus to:
receive web content for display on the screen,
obtain an analysis of the web content to determine an effective page height, the effective page height based in part on the first screen height,
determine a first portion of the web content to fit the effective page height, and
display the first portion of the web content on the screen at the effective page height.

9. The apparatus of claim 8, wherein the analysis of the web content is obtained, via a network from another device.

10. The apparatus of claim 8, wherein the memory contains program code, which when executed by the processor, causes the apparatus to provide, on the screen, a jump bar for receiving user inputs.

11. The apparatus of claim 8, wherein the memory contains program code, which when executed by the processor, causes the apparatus to:
responsive to receiving an input at the apparatus, determine a second portion of the web content to fit the effective page height, and
display the second portion of the web content on the screen at the effective page height.

12. The apparatus of claim 11, wherein the second portion is displayed on the screen below a start line.

13. The apparatus of claim 11, wherein the second portion of the web content comprises web content within the first portion of the web content.

14. The apparatus of claim 11, wherein the memory contains program code, which when executed by the processor, causes the apparatus to:
inject scrolling code into the web content,
scroll down from the top of the screen by a predetermined increment, to a first position, determine a height of a header object at the first position,
identify a footer object at a second position, and
determine the height of the footer object.

15. A non-transitory computer-readable medium comprising program code, which when executed by a processor, causes a terminal to:
receive, at the terminal comprising the processor, a memory and a screen having a first screen height, web content for display on the terminal;
obtain an analysis of the web content to determine an effective page height, the effective page height based in part on the first screen height;
determine a first portion of the web content to fit the effective page height; and
display the first portion of the web content on the screen at the effective page height.

16. The non-transitory computer-readable medium of claim 15, wherein the analysis is obtained, via a network from another device.

17. The non-transitory computer-readable medium of claim 15, comprising program code, which when executed by the processor, causes the terminal to provide, on the screen, a jump bar for receiving user inputs.

18. The non-transitory computer-readable medium of claim 15, comprising program code, which when executed by the processor, causes the terminal to:
responsive to receiving an input at the terminal, determine a second portion of the web content to fit the effective page height; and
display the second portion of the web content on the screen at the effective page height.

19. The non-transitory computer-readable medium of claim 18, wherein the second portion is displayed on the screen below a start line.

20. The non-transitory computer-readable medium of claim 18, wherein the second portion of the web content comprises web content within the first portion of the web content.
